(19) United States
(12) Patent Application Publication
(10) Pub. No.: US 2013/0328503 A1
(43) Pub. Date: Dec. 12, 2013

(54) ILLUMINATION CONTROLLER AND ILLUMINATION SYSTEM INCLUDING SAME

(71) Applicant: Panasonic Corporation, Osaka (JP)

(72) Inventor: Naohiro Toda, Osaka (JP)

(73) Assignee: Panasonic Corporation, Osaka (JP)

(21) Appl. No.: 13/905,300

(22) Filed: May 30, 2013

(30) Foreign Application Priority Data
Jun. 7, 2012 (JP) 2012-130255

(51) Int. Cl. H05B 37/02

(52) U.S. Cl. CPC H05B 37/02
USPC 315/297

(57) ABSTRACT

An illumination controller controls a light source unit having multiple types of light sources that emit light of different colors. The controller including: a dial, which is rotatable, used to adjust a color temperature and an illuminance of light irradiated from the light source unit; a memory which stores one or more control curves in which the color temperature and the illuminance of light irradiated from the light source unit change in conjunction with each other; and an adjustment unit used to adjust one of the control curves stored in the memory. Thus, when the dial is rotated, the color temperature and the illuminance of light irradiated from the light source unit change according to values determined by the control curve which is adjusted by the adjustment unit.

### FIELD OF THE INVENTION

The present invention relates to an illumination controller which controls a light source to change a color temperature and a quantity of light irradiated from the light source, and an illumination system including the same.

### BACKGROUND OF THE INVENTION

A color temperature and a quantity of light irradiated from a light source have many effects on human psychology. Through many experiments, it has been reported that there is a relationship between the color temperature and the quantity of the irradiated light and human psychology thereunder. Especially, the idea that “upper and lower limits of comfortable illuminance (quantity of light) vary depending on the color temperature” showed by Kruithof in 1941 is widely accepted.

As shown in FIG. 7, according to the experiments of Kruithof, a high color temperature light (e.g., pale light emitted from a daylight white fluorescent lamp, color temperature: ˜5000 K) gives off a refreshing impression to people in a case of high illuminance, but a dismal impression to people in a case of low illuminance. Contrarily, a low color temperature light (e.g., reddish light emitted from an incandescent lamp, color temperature: ˜2800 K) gives off a sultry impression to people in a case of high illuminance, but a gentle impression to people if it is adjusted to moderate illuminance. Thus, an illuminance which makes people feel comfortable or uncomfortable varies depending on the color temperature of the irradiated light.

In recent years, an illumination apparatus, which changes the color temperature of the irradiated light by combining light emitting diodes (LEDs) that emit red, green, and blue light, respectively, has been known. As an illumination apparatus of this type, for example, Japanese Patent Laid-open Publication No. 2009-117080 discloses an apparatus in which the quantity and the color temperature of irradiated light are changed only in the region where people feel comfortable, as shown in FIG. 7.

However, in the illumination apparatus described above, since the illuminance and the color temperature of irradiation light are adjusted manually, it is difficult for general users, who do not have expertise in illumination, to adjust the illuminance and the color temperature of irradiation light while keeping them in a good balance. Also, if there is another light source, general users may still find it difficult to modify the color temperature and the illuminance of irradiation light according to the corresponding illumination environment.

### SUMMARY OF THE INVENTION

In view of the above, the present invention provides an illumination controller that even general users can use to adjust a color temperature and an illuminance of light irradiated from a light source while keeping them in a good balance and to easily modify them according to an illumination environment, and an illumination system including the same.

In accordance with an aspect of the present invention, there is provided an illumination controller, which controls a light source unit having multiple types of light sources that emit light of different colors, the controller including: a dial, which is rotatable, used to adjust a color temperature and an illuminance of light irradiated from the light source unit; a memory which stores one or more control curves in which the color temperature and the illuminance of light irradiated from the light source unit change in conjunction with each other; and an adjustment unit used to adjust one of the control curves stored in the memory, wherein, when the dial is rotated, the color temperature and the illuminance of light irradiated from the light source unit change according to values determined by the control curve which is adjusted by the adjustment unit.

Preferably, the adjustment unit includes one or more illuminance adjustment buttons and/or one or more color temperature adjustment buttons.

The dial may be formed of a disc-shaped knob which is movable in a direction perpendicular to the rotational plane thereof. Accordingly, the dial may functions as the adjustment unit when the dial is moved in the direction perpendicular to the rotational plane.

Further, the controller may further include a display unit configured to represent an adjustment amount adjusted by the adjustment unit.

In accordance with another aspect of the present invention, there is provided an illumination system including the controller as described above.

Preferably, the control curves include a normal mode curve in which a variation width of the illuminance of light to a variation width of the color temperature is large in a low color temperature range and is small in a high color temperature range.

Further, the controller may further include a curve selection unit configured to select one among the control curves stored in the memory, and the adjustment unit may adjust the control curve selected by the curve selection unit.

The control curves may further include at least one of a wakeup mode curve in which the illuminance and the color temperature of light increase monotonically with the time at wakeup time; and a bedtime mode curve in which the color temperature of light is prevented from becoming a high color temperature.

Furthermore, the illumination system may further include a timer for starting and terminating an operation of the controller at a preset time.

With the above configuration, since the illuminance and the color temperature of light irradiated from the light source are changed according to the control curve in which the color temperature and the illuminance of light vary in conjunction with each other, even general users can adjust the illuminance and the color temperature of light while keeping them in a good balance. Further, since the control curve can be adjusted, it is possible to easily modify the illuminance and the color temperature of irradiation light according to the illumination environment.

### BRIEF DESCRIPTION OF THE DRAWINGS

The objects and features of the present invention will become apparent from the following description of embodiments, given in conjunction with the accompanying drawings, in which:

FIG. 1 is a configuration diagram of an illumination system in accordance with an embodiment of the present invention;

FIG. 2A is a block diagram of a power source unit included in the illumination system, and FIG. 2B is a circuit diagram of a drive unit provided in the power source unit;

FIG. 3 is a view for explaining a control curve used to adjust a color temperature and an illuminance of irradiation light in the illumination system;

FIG. 4A is a view for explaining rotation of a dial provided in a controller of the illumination system, and FIG. 4B is a diagram for explaining a manner of adjusting the color temperature and the illuminance of irradiation light by using the control curve;

FIG. 5A illustrates an example of a controller according to a first modification of the above embodiment, and FIG. 5B shows another example of the controller according to the first modification;

FIG. 6A and FIG. 6B are a front view and a side view of a controller according to a second modification of the above embodiment, respectively; and

FIG. 7 is a diagram showing a relationship between a color temperature and an illuminance of irradiation light and the impression which people receives therefrom.

### DETAILED DESCRIPTION OF THE EMBODIMENTS

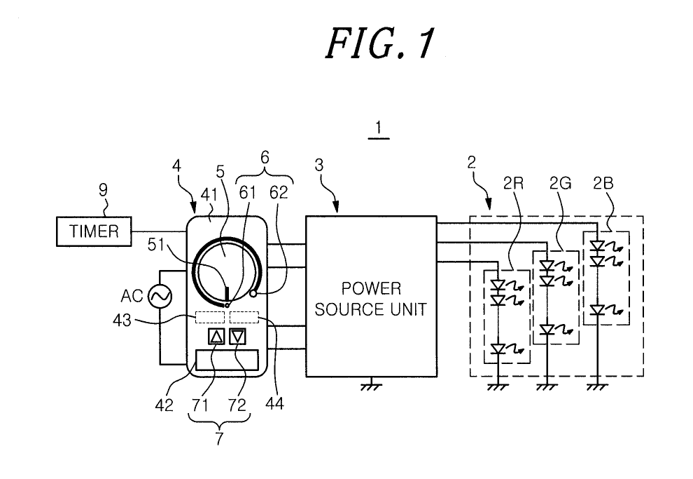

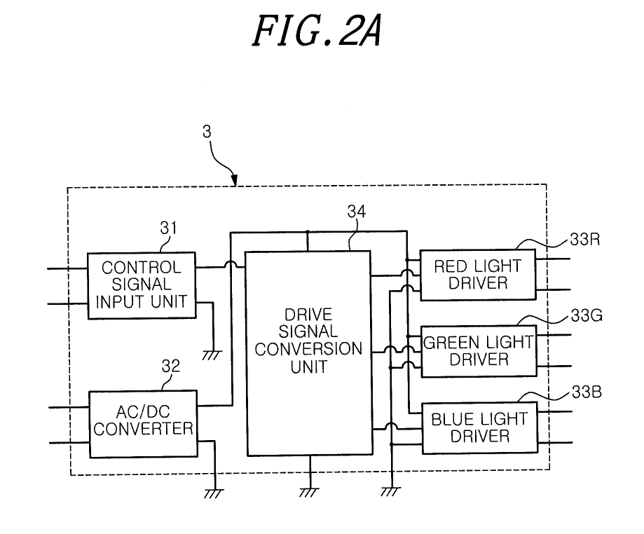

A color temperature variable illumination system (hereinafter, referred to as an illumination system) in accordance with an embodiment of the present invention will be described with reference to FIGS. 1 to 4.

As shown in FIG. 1, an illumination system 1 according to the present embodiment includes a light source unit 2; a power source unit 3 for controlling the power supply to the light source unit 2; and a controller 4 for controlling an operation of the power source unit 3 in response to an input from a user.

The light source unit 2 has multiple types of light sources that emit different colored lights: for example, a red light source 2R (R: Red) that emits red light, a green light source 2G (G: Green) that emits green light, and a blue light source 2B (B: Blue) that emits blue light. The red light source 2R includes a plurality of red LEDs connected in series to each other. The green light source 2G includes a plurality of green LEDs connected in series to each other. The blue light source 2B includes a plurality of blue LEDs connected in series to each other.

The controller 4 includes a rectangular box-shaped housing 41 which is fixed to, e.g., a wall surface of a room where the illumination system 1 is installed. Provided on one surface of the housing 41 are a power switch 42 for turning on and off of the light source unit 2, and a rotatable dial 5 used to adjust the color temperature and the illuminance of light irradiated from the light source unit 2. Further, marks 61 and 62 are provided to indicate rotation locations of the dial 5. The power switch 42 is formed of a pushbutton switch, which opens and closes a power supply circuit from an AC power source to the power source unit 3. When the dial 5 is likened to a clock, the marks 61 and 62 are provided at 6 o'clock and 4 o'clock positions around the dial 5, respectively.

The dial 5 is formed of a disc-shaped knob and has an indicator 51 for representing its own rotational position on the surface thereof. The dial 5 is rotated within a certain rotational range, and upper and lower limits of the color temperature and the illuminance of irradiation light are set within the rotation range. In the present embodiment, the dial 5 is configured such that the indicator 51 is rotatable by approximately 300° between the mark 61 and the mark 62.

When the indicator 51 of the dial 5 meets the mark 61, the illuminance and the color temperature of light irradiated from the light source unit 2 become the minimum. When the indicator 51 meets the mark 62, the illuminance and the color temperature of light irradiated from the light source unit 2 become the maximum. Further, the dial 5 may be configured to be rotated smoothly or may be configured to click when it is rotated.

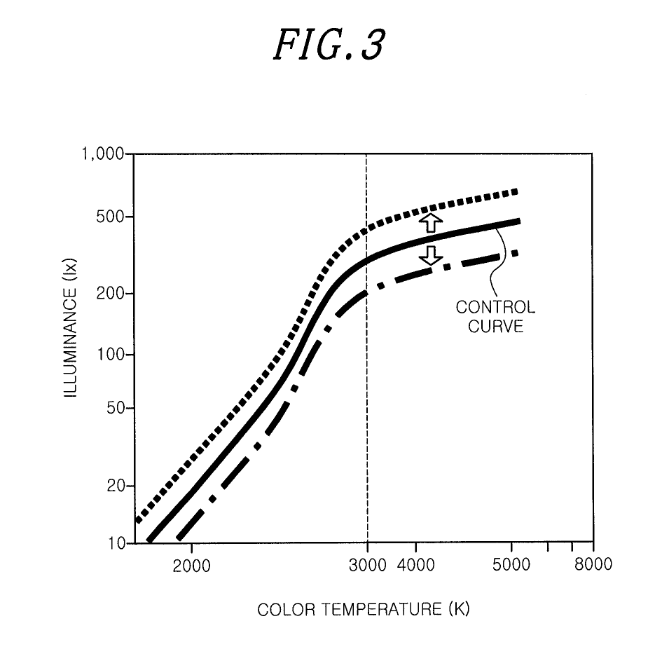

Further, the controller 4 has a memory 43 for storing a control curve in which the color temperature and the illuminance of light change in conjunction with each other. Furthermore, the controller 4 has an adjustment unit 7 for adjusting the corresponding control curve. In the present embodiment, the adjustment unit 7 is constituted by, e.g., two adjustment buttons 71 and 72. The control curve and the adjustment unit 7 will be described in detail with reference to FIG. 3. In addition, the controller 4 has a control unit 44 for generating a control signal in response to an input from the user, thereby controlling light emission of the light source unit 2.

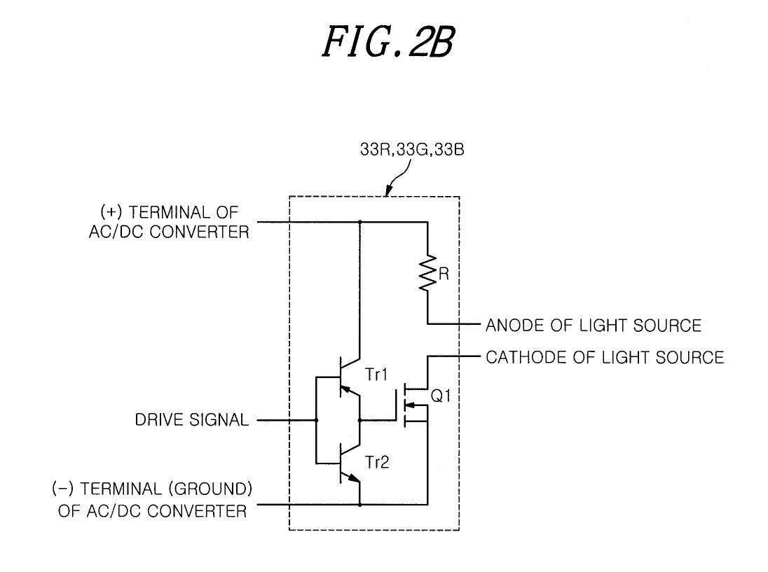

Referring to FIG. 2A, the power source unit 3 has a control signal input unit 31 to which a control signal is inputted from a control unit 44 of the controller 4, and an AC/DC converter 32 which converts an AC voltage, supplied from the AC power source AC through the controller 4, into a desired DC voltage. Further, the power source unit 3 has a red light driver 33R for driving the red light source 2R, a green light driver 33G for driving the green light source 2G, and a blue light driver 33B for driving the blue light source 2B. Further, the power source unit 3 includes a drive signal conversion unit 34 which converts a control signal, inputted through the control signal input unit 31, into a drive signal for driving each of the drivers 33R, 33G, and 33B. The drive signal conversion unit 34 outputs a drive signal of a square wave signal whose on-duty ratio is variable and having a predetermined period.

The drivers 33R, 33G, and 33B have the same configuration. As shown in FIG. 2B, each of the drivers 33R, 33G, and 33B has a resistor R as a current-limiter, and the resistor R is inserted between the anode of each of the light sources 2R, 2G, and 2B and the positive (+) terminal of the AC/DC converter 32. Further, each of the drivers 33R, 33G, and 33B has a switching element Q1 which is connected to the cathode of each of the light sources 2R, 2G, and 2B and has a drain connected to the negative (−) terminal (ground) of the AC/DC converter 32. The switching element Q1 is constituted by a field effect transistor.

Further, each of the drivers 33R, 33G, and 33B has a waveform shaping circuit including two transistors Tr1 and Tr2 connected in parallel to each other. The transistor Tr1 is formed of a PNP-type bipolar transistor having a collector connected to the positive (+) terminal of the AC/DC converter 32 and an emitter connected to the gate of the switching element Q1. Further, the transistor Tr2 is constituted by an NPN-type bipolar transistor which has a collector connected to the gate of the switching element Q1 and an emitter connected to the negative (−) terminal (ground) of the AC/DC converter 32. The waveform shaping circuit performs pulse width modulation (PWM) control on the switching element Q1 based on the drive signal from the drive signal conversion unit 34 inputted to the bases of the transistors Tr1 and Tr2, thereby adjusting the amount of power supplied to each of the light sources 2R, 2G, and 2B.

In the illumination system 1 configured as the above, when the dial 5 of the controller 4 rotates, the color temperature and the illuminance of light irradiated from the light source unit 2 changes according to the control curve. As shown in FIG. 3, the control curve (represented by a thick solid line) is defined such that the color temperature and the illuminance of light change in conjunction with each other in a region where people feel comfortable, which is known by Kruithof's experiments. Accordingly, the illuminance and the color temperature of light are adjusted properly while keeping them in a good balance. As a result, it is possible to obtain the irradiation light which makes the user feel comfortable.

In the present embodiment, the control curve (normal mode curve) is defined such that a variation width of the illuminance (quantity of light) to a variation width of the color temperature is large in a low color temperature range (<3000 K), and is small in a high color temperature range ≧3000 K). In normal use, a rated power of light is substantially sufficient in a high color temperature range, so supplying a larger quantity of light than that is not preferable from an energy saving point of view. Therefore, in the normal mode control curve, an increase of the illuminance (quantity of light) is suppressed in the high color temperature range. By using this control curve, it is possible to reduce the power consumption of the light source unit 2 while keeping a good balance between the color temperature and the illuminance of light.

As described above, the balance between the color temperature and the illuminance of light is kept properly in the illumination system 1. However, the illumination environment may vary according to the number of illumination systems 1 which is installed, the size of the room where the illumination system 1 is installed, or the existence of another light source other than the illumination system 1, and it may be desired to modify the illuminance of light irradiated from the light source in the illumination system 1.

In this case, the adjustment unit 7 is used to shift the control curve toward the high illuminance side or the low illuminance side. The adjustment button 71 shifts the control curve to the high illuminance side and the adjustment button 72 shifts the control curve to the low illuminance side, in the illuminance-color temperature coordinates shown in FIG. 3. In FIG. 3, the control curve shifted to the high illuminance side is represented by a dotted line, and the control curve shifted to the low illuminance side is represented by a dashed dotted line.

That is, by pressing the adjustment button 71 and shifting the control curve to the high illuminance side, it is possible to increase the illuminance of light while constantly maintaining the color temperature of irradiation light. Further, by pressing the adjustment button 72 and shifting the control curve to the low illuminance side, it is possible to decrease the illuminance of light while constantly maintaining the color temperature of irradiation light. By doing this, it is possible to adjust the illuminance of light irradiated from the light source unit 2 of the illumination system 1. Further, when operating the dial 5 after shifting the control curve, the color temperature and the illuminance of irradiation light are adjusted according to the shifted control curve.

Data on the control curve shifted by the above operation is stored in the memory 43 of the controller 4, and does not disappear even if the illumination system 1 is turned off. Thus, when starting the illumination system 1 at the next time, the last shifted control curve is called, and it is possible to adjust the color temperature and the illuminance of irradiation light according to the last shifted control curve. Further, the controller 4 may have a return button (not shown) to return to an initial state, e.g., a state before the control curve is shifted.

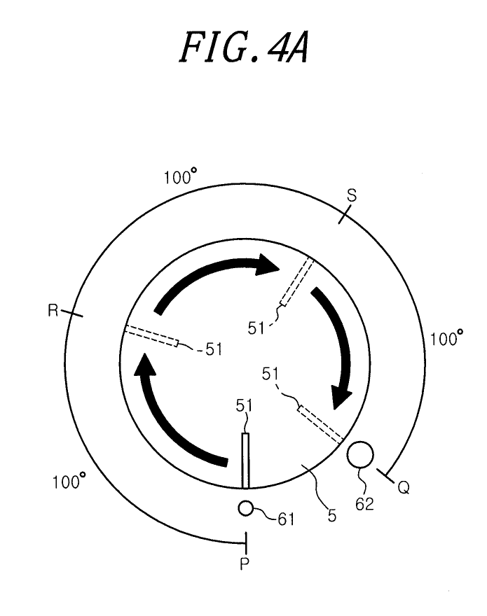

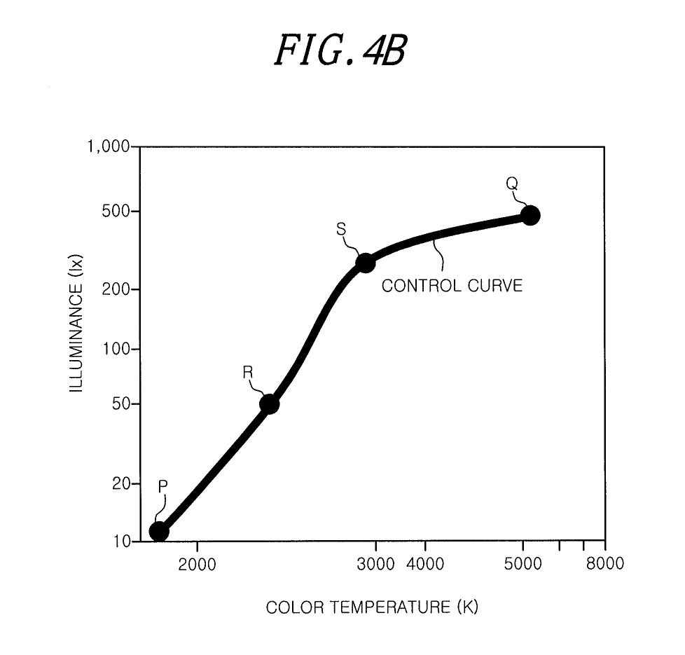

In adjusting the color temperature and the illuminance of irradiation light, the control unit 44 of the controller determines variations in the color temperature and the illuminance of light by associating the rotational angle of the dial 5 with the length on the control curve. This mechanism will be described with reference to FIGS. 4A and 4B.

As described above, the dial 5 is configured such that the indicator 51 is rotatable by approximately 300° between the mark 61 and the mark 62 (see FIG. 4A). The color temperature and the illuminance of light when the indicator of the dial 5 meets the mark 61, correspond to values defined at end point P on the side of the low illuminance (low quantity of light) and low color temperature of the control curve (see FIG. 4B). Further, the color temperature and the illuminance of irradiation light when the indicator of the dial 5 meets the mark 62, correspond to values defined at end point Q on the side of the high illuminance (high quantity of light) and high color temperature of the control curve. Hereinafter, the length between end points P and Q on the control curve is referred to as L.

When the dial 5 is rotated by approximately 100° (⅓ of the total rotation) from the state where the indicator 51 meets the mark 61, values defined at point R shifted by the amount of (⅓)L toward the side of the high illuminance (high quantity of light) and high color temperature from the end point P on the control curve are assigned as the color temperature and the illuminance of irradiation light. Then, when the dial 5 is further rotated by 100° (rotated by 200° in total from the mark 61, ⅔ of the total rotation), values defined at point S further shifted by the amount of (⅓)L toward the side of the high illuminance and high color temperature from the point R on the control curve are assigned as the color temperature and the illuminance of irradiation light.

In this way, by associating the rotational angle of the dial 5 with the length on the control curve, the rotational angle of the dial 5 corresponds to the variations in the color temperature and the illuminance of irradiation light. Thus, it is possible to smoothly adjust the color temperature and the illuminance of irradiation light. Particularly, it facilitates fine adjustment of the illuminance (quantity of light) and the color temperature in a region (near the point R of FIG. 4B) where the variation width of the illuminance to the variation width of the color temperature is large in the control curve, or a region (near the point S of FIG. 4B) where the variation width of the color temperature to the variation width of the illuminance is large.

With the illumination system 1 of the present embodiment as described above, since the color temperature and the illuminance of light irradiated from the light source unit 2 change according to the control curve, even general users who do not have expertise in illumination can adjust the color temperature and the illuminance of irradiation light while keeping them in a good balance. Further, since the control curve can be shifted to the high illuminance side or low illuminance side, the illuminance of irradiation light can be easily adjusted according to the illumination environment.

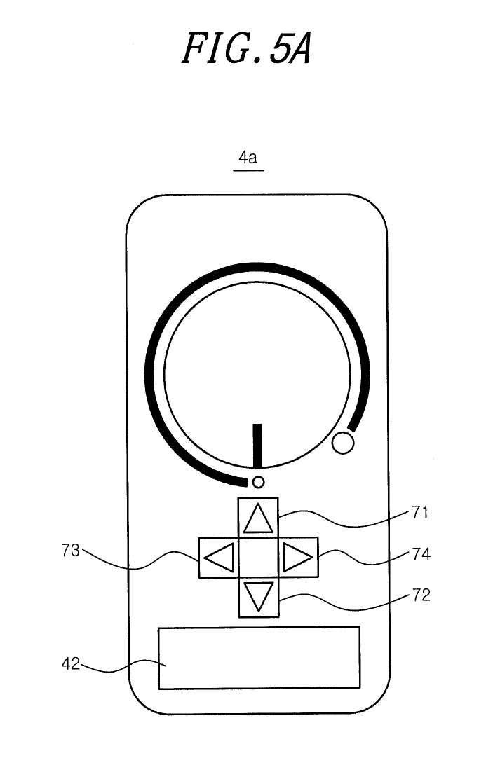

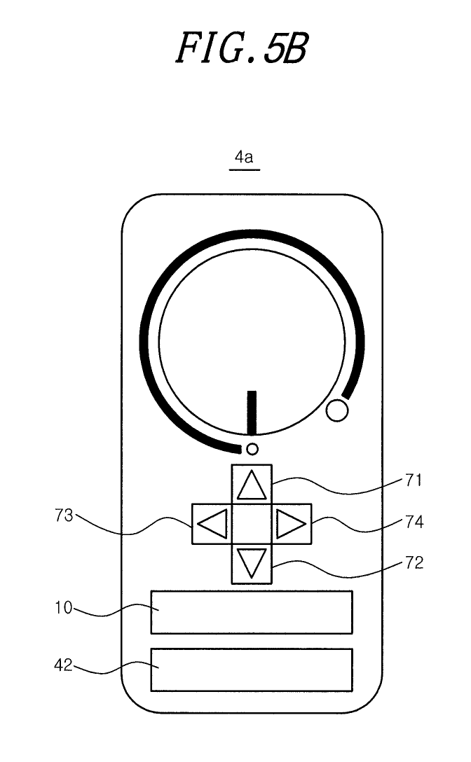

Next, a controller according to a first modification of the above embodiment will be described with reference to FIG. 5A. A controller 4a of this modification is different from the above-mentioned controller 4 in that there are further provided an adjustment button 73 which shifts the control curve to the low color temperature side and an adjustment button 74 which shifts the control curve to the high color temperature side in the illuminance-color temperature coordinates. By using the controller 4a, both the color temperature and the illuminance of irradiation light can be easily adjusted according to the illumination environment.

In the forgoing description, although the adjustment buttons 73 and 74 are provided in addition to the adjustment buttons 71 and 72, the adjustment buttons 71 and 72 may be substituted by the adjustment buttons 73 and 74. Alternatively, one, or three or more buttons may be provided for the illuminance adjustment or for the color temperature adjustment.

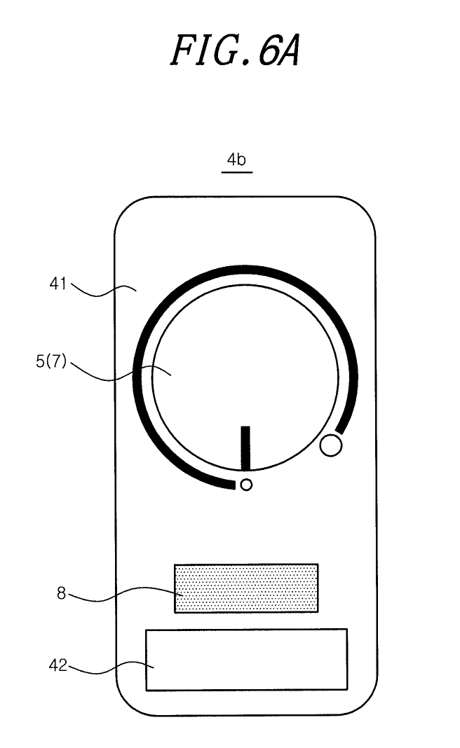

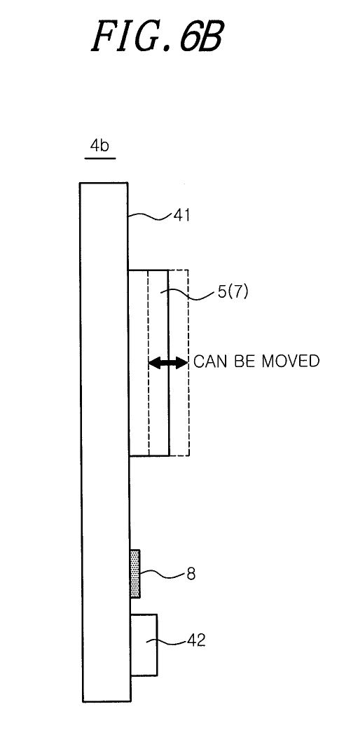

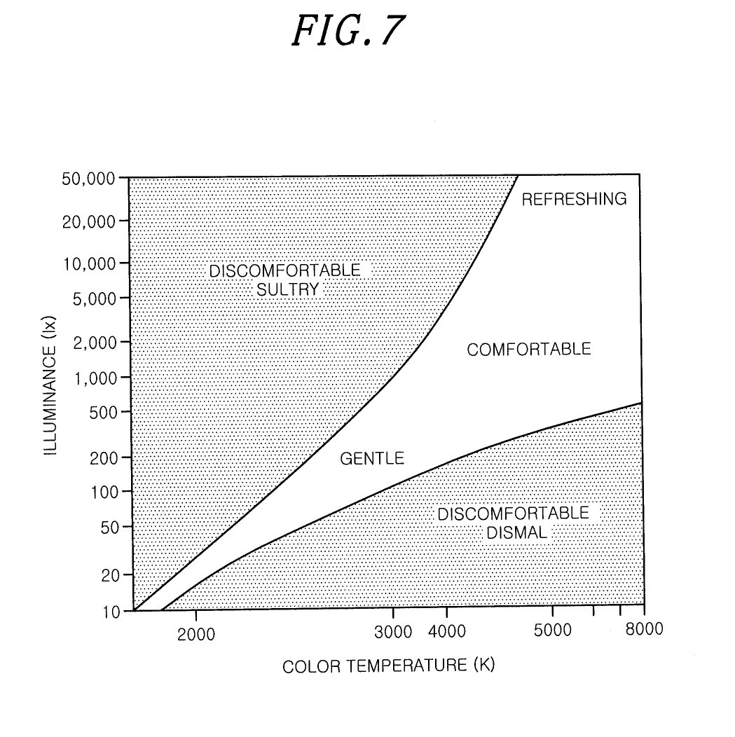

Next, a controller according to a second modification of the above embodiment will be described with reference to FIGS. 6A and 6B. In a controller 4b of this modification, the dial 5, which is rotatable, is also configured to be moved in a direction perpendicular to the rotational plane. Accordingly, the color temperature and the illuminance of irradiation light are adjusted when the dial 5 is rotated, and the dial 5 functions as the adjustment unit 7 for shifting the control curve when it is moved in a direction perpendicular to the rotational plane.

Specifically, when the dial 5 is pushed toward the housing 41, the control curve is shifted to the high illuminance side in the illuminance-color temperature coordinates. On the contrary, when the dial 5 is pulled out in a direction opposite to the housing 41, the control curve is shifted to the low illuminance side in the illuminance-color temperature coordinates. By using the dial 5 to function as the adjustment unit 7 as such, the number of components constituting the controller 4b becomes fewer, assembly efficiency of the controller 4b is improved, and the appearance of the controller 4b is simplified and improved.

In this modification, the dial is configured to function as the adjustment unit for shifting the control curve toward the low illuminance side or the high illuminance side when it is pulled out or pushed. However, it may be configured to shift the control curve toward the high color temperature and the low color temperature, or the like.

Further, the controller 4b has a display unit 8 which represents an adjustment amount of the control curve by the adjustment unit 7 (dial 5). The display unit 8 has, e.g., light emitters that emit multiple colors of light, and notifies the user of the adjustment amount adjusted by the adjustment unit 7 through the emission pattern of the light emitters. For example, the display unit 8 is configured to emit blue light if the dial 5 is pushed in the direction toward the housing 41, and the blue becomes darker as the amount of the dial 5 pushed increases. In this way, the user can easily know the adjustment amount adjusted by the adjustment unit 7. Further, the display unit 8 is not limited to the configuration using the light emitters, and for example, may include a liquid crystal panel to display the adjustment amount thereon.

The illumination controller and the illumination system including the same according to the present invention are not limited to the above embodiment and its modifications, and various modifications can be made. For example, it may be configured such that multiple control curves are stored in the memory of the controller and one control curve among the multiple control curves is selected appropriately by a curve selection unit 10 (see FIG. 5B) according to the illumination environment.

Further, another control curve may be provided in addition to that described in the above embodiment. For example, there may be included a wakeup mode curve in which the illuminance and the color temperature of light monotonically increase with the time at wakeup time, or a bedtime mode curve in which the color temperature is prevented from becoming a high color temperature. Further, the illumination system may include a timer to thereby start and terminate the operation of the controller at a preset time (see, e.g., timer 9 in FIG. 1). Accordingly, the illumination system can automatically start to operate when it becomes the preset time.

While the invention has been shown and described with respect to the embodiments, it will be understood by those skilled in the art that various changes and modification may be made without departing from the scope of the invention as defined in the following claims.

What is claimed is:

1. An illumination controller, which controls a light source unit having multiple types of light sources that emit light of different colors, the controller comprising:
a dial, which is rotatable, used to adjust a color temperature and an illuminance of light irradiated from the light source unit;
a memory which stores one or more control curves in which the color temperature and the illuminance of light irradiated from the light source unit change in conjunction with each other; and
an adjustment unit used to adjust one of the control curves stored in the memory,
wherein, when the dial is rotated, the color temperature and the illuminance of light irradiated from the light source unit change according to values determined by the control curve which is adjusted by the adjustment unit.

2. The controller of claim 1, wherein the adjustment unit includes one or more illuminance adjustment buttons and/or one or more color temperature adjustment buttons.

3. The controller of claim 1, wherein the dial is formed of a disc-shaped knob which is movable in a direction perpendicular to the rotational plane thereof, and
wherein the dial functions as the adjustment unit when the dial is moved in the direction perpendicular to the rotational plane.

4. The controller of claim 1, further comprising a display unit configured to represent an adjustment amount adjusted by the adjustment unit.

5. The controller of claim 2, further comprising a display unit configured to represent an adjustment amount adjusted by the adjustment unit.

6. The controller of claim 3, further comprising a display unit configured to represent an adjustment amount adjusted by the adjustment unit.

7. An illumination system comprising the controller described in claim 1.

8. The system of claim 7, wherein the adjustment unit includes one or more illuminance adjustment buttons and/or one or more color temperature adjustment buttons.

9. The system of claim 7, wherein the dial is formed of a disc-shaped knob which is movable in a direction perpendicular to the rotational plane thereof, and
wherein the dial functions as the adjustment unit when the dial is moved in the direction perpendicular to the rotational plane.

10. The system of claim 7, further comprising a display unit configured to represent an adjustment amount adjusted by the adjustment unit.

11. The system of claim 7, wherein the control curves include a normal mode curve in which a variation width of the illuminance of light to a variation width of the color temperature is large in a low color temperature range and is small in a high color temperature range.

12. The system of claim 8, wherein the control curves include a normal mode curve in which a variation width of the illuminance of light to a variation width of the color temperature is large in a low color temperature range and is small in a high color temperature range.

13. The system of claim 9, wherein the control curves include a normal mode curve in which a variation width of the illuminance of light to a variation width of the color temperature is large in a low color temperature range and is small in a high color temperature range.

14. The system of claim 10, wherein the control curves include a normal mode curve in which a variation width of the illuminance of light to a variation width of the color temperature is large in a low color temperature range and is small in a high color temperature range.

15. The system of claim 11,
wherein the controller further includes a curve selection unit configured to select one among the control curves stored in the memory,
wherein the adjustment unit adjusts the control curve selected by the curve selection unit.

16. The system of claim 15, wherein the control curves further include at least one of a wakeup mode curve in which the illuminance and the color temperature of light increase monotonically with the time at wakeup time; and a bedtime mode curve in which the color temperature of light is prevented from becoming a high color temperature.

17. The system of claim 16, further comprising a timer for starting and terminating an operation of the controller at a preset time.
